(19) United States
(12) Patent Application Publication
(10) Pub. No.: US 2010/0001035 A1
(43) Pub. Date: Jan. 7, 2010

(54) DESK ACCESSORY WITH USB HUB

(76) Inventor: Bonni Shevin Sandy, Morton Grove, IL (US)

Correspondence Address: PERKINS COIE LLP, POST OFFICE BOX 1208, SEATTLE, WA, 98111-1208, US

(21) Appl. No.: 12/167,115

(22) Filed: Jul. 2, 2008

(51) Int. Cl. B25C 5/00

(52) U.S. Cl. 227/138; 439/607.55

(57) ABSTRACT

A combination desk accessory and USB device includes an electric motor or mechanism in a housing, and USB ports on the housing. A least one of the USB ports is electrically linked to the electric motor or mechanism for providing power to the motor or mechanism. Batteries may optionally be provided in a battery compartment in the housing, with the battery compartment electrically linked to the electric motor or mechanism and to one or more of the USB ports. A power supply circuit electrically connected to at least one of the USB ports, the battery compartment and motor or mechanism, may be provided to control electrical power. The desk accessory may be an electric stapler, pencil sharpener, letter opener, fan, or similar electrically powered device.

### SUMMARY

The field of the invention is desk and office products and accessories. A multipurpose device is disclosed useful for conveniently conserving desktop space by integrating a stapler base with a Universal Serial Bus (“USB”) hub. Thus, potential desk clutter and misplacing objects are reduced.

In one embodiment, a stapler is provided with USB ports and an electrically actuated stapler mechanism. The mechanism may be supplied with electrical power via one of the USB ports, so that an additional AC line cord is not needed. The stapler can be connected to other USB devices and serve as an USB hub for convenient accessibility.

Other objects, features and advantages will be apparent from the following detailed description, which shows alternative embodiments. The drawings are provided to show an example and should not be understood as limitations on the scope of the invention. The invention resides as well in sub combinations of the elements described and shown.

### BRIEF DESCRIPTION OF THE DRAWINGS

FIG. 1 is a top front left side perspective view of a new desk accessory or stapler.

FIG. 2 is a rear view of a the stapler shown in FIG. 1.

FIG. 3 is a right side view.

FIG. 4 is a left side view.

### DETAILED DESCRIPTION OF THE DRAWINGS

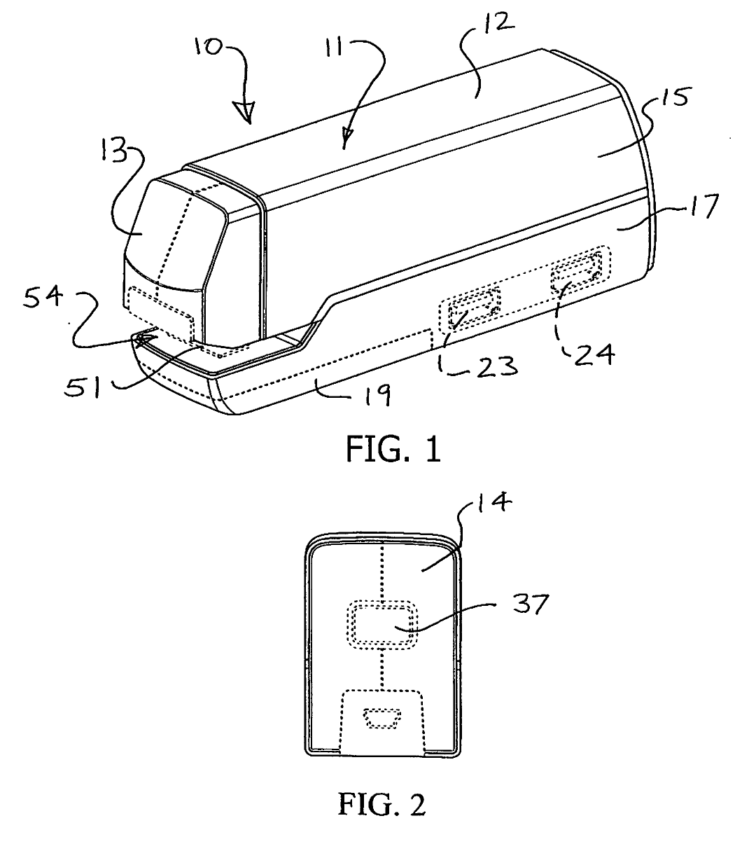

Turning to FIGS. 1-4, a desk accessory base is provided in the form of a stapler 10 having a substantially rectangular body 11 with rounded edges. The body 11 has a top surface 12, a front end 13, a back end 14, and a stapler base 19. The top surface 12 may be flat and smooth, with the back end slightly rounded and smooth. The body 11 typically also has right and left body panels, which are also generally smooth and flat.

In the design as shown, the lower left body panel 17 and lower right body panel 18 contain the Universal Serial Bus (“USB”) ports 21-24. USB ports 21-24 serve as a USB hub that can extend connectivity to other USB devices. For example, USB compatible devices such as memory sticks, printers, digital cameras, scanners, etc. may be attached to USB ports 21-24. The specific number of ports, and the location of the ports, may vary.

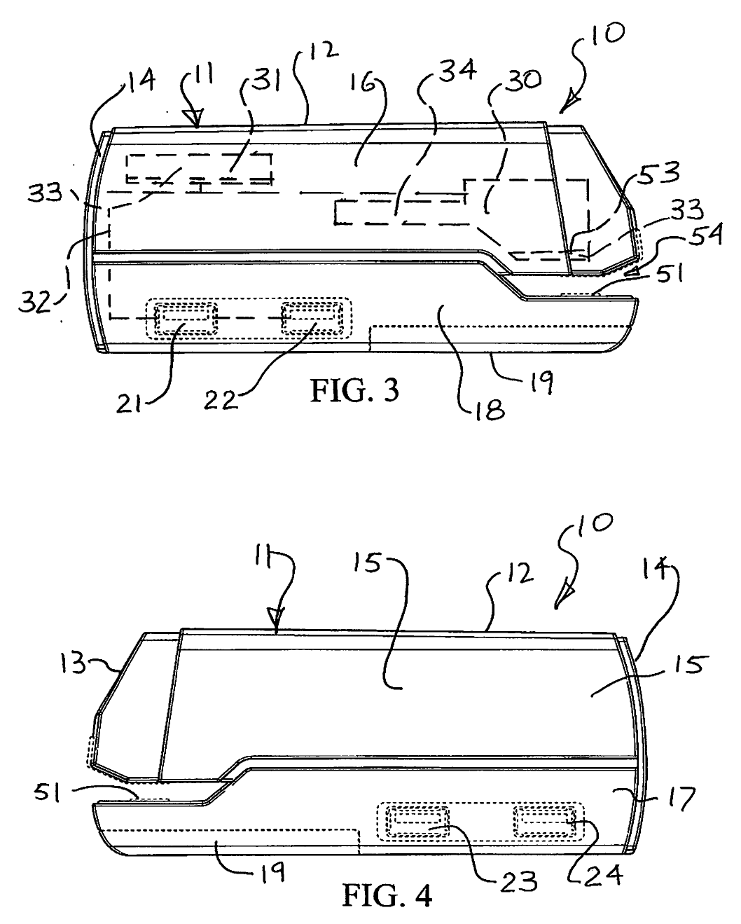

As shown in FIG. 3, an electric stapler mechanism 30 is provided within the front end 13 of the stapler 10 and a sensor switch 33. A sensor switch 33 shown in FIG. 3, activates the electric stapler unit 30 when papers are inserted into the slot 54. A crimper plate 51 is attached at the foot of base 19 to crimp staples as they are pressed out of the electric stapler mechanism 30. An internal magazine 34 attached to the stapler mechanism 30 holds a strip of staples and feeds them into the stapler mechanism. The magazine may be opened and refilled via a rear access door 37 shown in FIG. 2.

As shown in FIG. 3, a battery compartment 31 holding batteries may be provided within the stapler 10 to optionally provide battery power. The battery compartment 31 is electrically wired to the stapler unit 30. The batteries supply power to the stapler unit 30 in the event when one or all of the USB ports 21-24 are disconnected from an external power source, or a device providing electrical power to the stapler 10. The batteries may be rechargeable. In this case, the batteries are charged while electrical power is supplied to one or more of USB ports. Wires or other conductors 32 connects at least one, and optionally all, USB port to the electric stapler mechanism 30, and to the battery compartment 31, if used, to for recharging the batteries, and to provide power to the stapler mechanism if no power is available from the USB ports. Thus the USB ports may serve as the primary power source for the stapler mechanism 30, with the batteries serving as a back up power supply. A power supply/switching circuit 33 connected to one or all of the USB ports, the batteries, and the stapler mechanism 30, may be used to switch between the primary and backup power sources, and to control battery charging.

The concepts described above may be applied to other types of desk or office accessories. For example, the concepts may be applied to an electric pencil sharpener, an electric letter opener, or other electric accessory. In each case, the 110 VAC line cord typically required for the accessory can be eliminated, since the accessory is powered via a USB connection. In addition, since the desk accessory is typically placed on a desk, the USB ports on the accessory are conveniently located and easily accessible, in contrast to the USB ports on desktop computer, which is generally located on the floor.

Novel desk accessories have been shown and described. Various substitutions and changes may of course be made without departing from the spirit and scope of the invention. The invention, therefore, should not be restricted except by the following claims and their equivalents.

1. A desk accessory, comprising:
a housing;
an electric stapler mechanism within the housing;
one or more USB ports on the housing electrically linked to the stapler mechanism

2. The desk accessory of claim 1 further comprising one or more batteries in a battery compartment in the housing, with the battery compartment electrically linked to the electric stapler mechanism and to one or more of the USB ports.

3. The desk accessory of claim 1 with the housing having substantially flat sides and rounded edges.

4. A combination stapler and USB hub comprising:
a stapler base;
a body attached to the base;
an electrical stapler mechanism in the body;
a stapler crimper on the base;
a plurality of USB ports in the base;
a battery compartment in the body and electrically connected to the stapler mechanism to supply auxiliary power to the stapler mechanism;
one or more batteries in the battery compartment;
a power supply circuit electrically connected to at least one of the USB ports, the battery compartment and the stapler mechanism.

5. A combination desk accessory and USB device comprising:
a housing;
an electric motor or mechanism in the housing;
a plurality of USB ports on the housing; and
at least one of the USB ports electrically linked to the electric motor or mechanism for providing power to the motor or mechanism.

6. The combination desk accessory and USB device of claim 5 further comprising one or more batteries in a battery compartment in the housing, with the battery compartment electrically linked to the electric motor or mechanism and to one or more of the USB ports.

7. The combination desk accessory and USB device of claim 5 further comprising a power supply circuit electrically connected to at least one of the USB ports, the battery compartment and motor or mechanism.

8. The device of claim 5 further comprising a battery compartment within the body for holding batteries to supply auxiliary power to the electric stapler mechanism.
